(19) United States
(12) Patent Application Publication
(10) Pub. No.: US 2025/0050214 A1
(43) Pub. Date: Feb. 13, 2025

(54) VIRTUAL GAMEPLAY COACH

(71) Applicant: SONY INTERACTIVE ENTERTAINMENT LLC, SAN MATEO, CA (US)

(72) Inventors: Kristie Fisher, San Mateo, CA (US); Jillian Moore, San Mateo, CA (US); Rae Yip, San Mateo, CA (US); Danielle Bunch, San Mateo, CA (US); Julie Ahn, San Mateo, CA (US); Daniel Reifsnider, San Mateo, CA (US); Steven Osman, San Mateo, CA (US)

(21) Appl. No.: 18/231,124

(22) Filed: Aug. 7, 2023

(51) Int. Cl. A63F 13/5375; A63F 13/67; A63F 13/79

(52) U.S. Cl. CPC A63F 13/5375; A63F 13/67; A63F 13/79

(57) ABSTRACT

A system and method for providing a customized gameplay coaching is disclosed. Historical game data from one or more users on a virtual platform is received by the system. The historical game data includes user activities associated with one or more media titles. A learning model of outcomes is generated for each user activity based on the historical game data. A customized recommendation associated with the user activity is generated based on the generated learning model. An outcome of the recommendation is tracked based on determining that the user executed the one or more steps based on the recommendation and the learning model is updated based on the outcome. The customized recommendation is updated based on the updated learning model.

### BACKGROUND OF THE INVENTION

### 1. Field of the Invention

The present system generally relates to providing a customized in-game coaching. More specifically, the present system relates to providing a customized recommendation specific to a user of an entertainment device based on a learning model.

### 2. Description of the Related Art

Presently available interactive media such as a video game may be associated with tutorials regarding the mechanics or details about a game title. Some tutorials, supplemental information (e.g., combo guide, map, or other resource), or other training materials may be distributed with or included in the game, and additional material may be created by third parties, such as other users that have played the game. However, in both cases these training materials need to be generated manually and may only cover specific cases. Such currently available resources are not personalized to the specific needs of the players.

Moreover, users that are new or unfamiliar with gameplay may not even be aware of the availability of training materials, may find it difficult to identify and retrieve relevant training materials specific to the needs of the player, and/or may be frustrated by the need to continually start and stop gameplay to access the training materials. Furthermore, no current training material or tutorial may be available to assist the user in overcoming the challenge. A user struggling with a particular step or a section of a gameplay experience due to the difficulty of accessing coaching material or the lack of coaching material, may result in a discontinued engagement of the user with the game.

Therefore, there is a need to provide a customized virtual gameplay coach that facilitates acquisition of skills and distribution of related information associated with the primary gameplay of a user by automatically generating tutorials and training material based on gameplay of the user and other users.

### SUMMARY OF THE CLAIMED INVENTION

Embodiments of the present invention include methods for providing a customized gameplay coaching. The methods include receiving historical game data from one or more users on a virtual platform, generating a learning model of outcomes for each user activity based on the historical game data, generating a customized recommendation associated with the user activity based on the generated learning model, tracking an outcome of the recommendation based on determining that the user executed the one or more steps based on the recommendation, updating the learning model based on the outcome, and updating the customized recommendation based on the updated learning model.

Embodiments of the present invention include systems for providing a customized in-game audio experience. The system includes a memory; a communication interface that may receive data sent over a communication network regarding historical game data from one or more users on a virtual platform that includes user activities associated with one or more media titles; a processor that executes instructions stored in memory that may generate a customized recommendation associated with the user activity based on the generated learning model, track an outcome of the recommendation based on determining that the user executed the one or more steps based on the recommendation, update the learning model based on the outcome, and update the customized recommendation based on the updated learning model.

Embodiments of the present invention also include a non-transitory computer-readable storage medium having embodied thereon a program, the program being executable by a processor to perform a method for providing a customized in-game audio experience. The methods include receiving historical game data from one or more users on a virtual platform, generating a learning model of outcomes for each user activity based on the historical game data, generating a customized recommendation associated with the user activity based on the generated learning model, tracking an outcome of the recommendation based on determining that the user executed the one or more steps based on the recommendation, updating the learning model based on the outcome, and updating the customized recommendation based on the updated learning model.

### BRIEF DESCRIPTION OF THE DRAWINGS

FIG. 1 illustrates an exemplary network environment in which a system for virtual gameplay coaching may be implemented.

FIG. 2 illustrates an exemplary uniform data system (UDS) that may be used to provide data to a system for providing virtual gameplay coaching.

FIG. 3 is a flowchart illustrating an exemplary method for the virtual gameplay coach.

FIG. 4 illustrates an exemplary graphical user interface display.

FIG. 5 illustrates a block diagram of an exemplary device.

### DETAILED DESCRIPTION

Embodiments of the present invention include systems and methods for providing virtual gameplay coaching. The virtual gameplay coaching assists a play of a game by training an artificial intelligence (AI) model that observes in-game activities of users and the outcomes of the activities to generate a customized recommendation for a specific in-game challenge based on the evaluated outcomes. The customized recommendation may be updated based on the tracked outcome of the recommendations. The AI model is updated based on the user activity and the associated tracked outcome of the recommendation to generate more refined recommendations in the future.

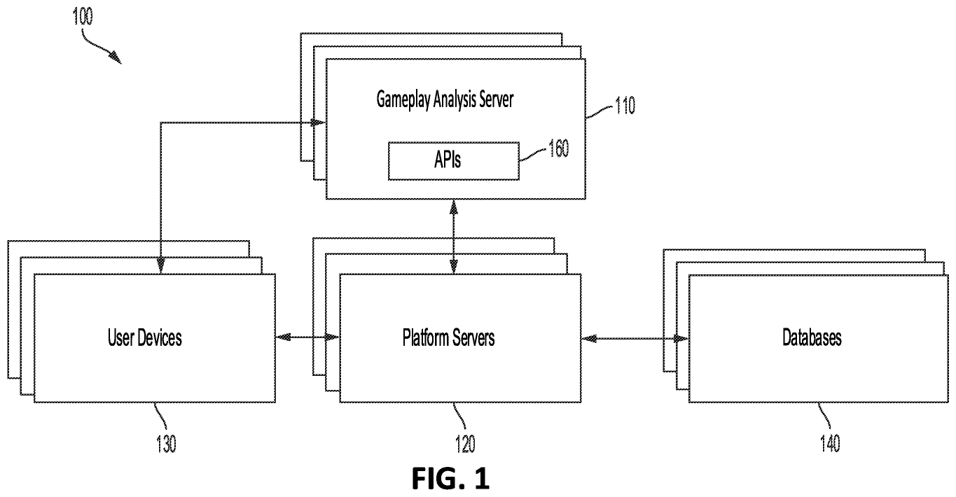

FIG. 1 illustrates an exemplary network environment in which a system for providing a virtual gameplay coaching may be implemented. The network environment 100 may include one or more gameplay analysis servers 110 that analyzes game data, one or more platform servers 120, one or more user devices 130, and one or more databases 140.

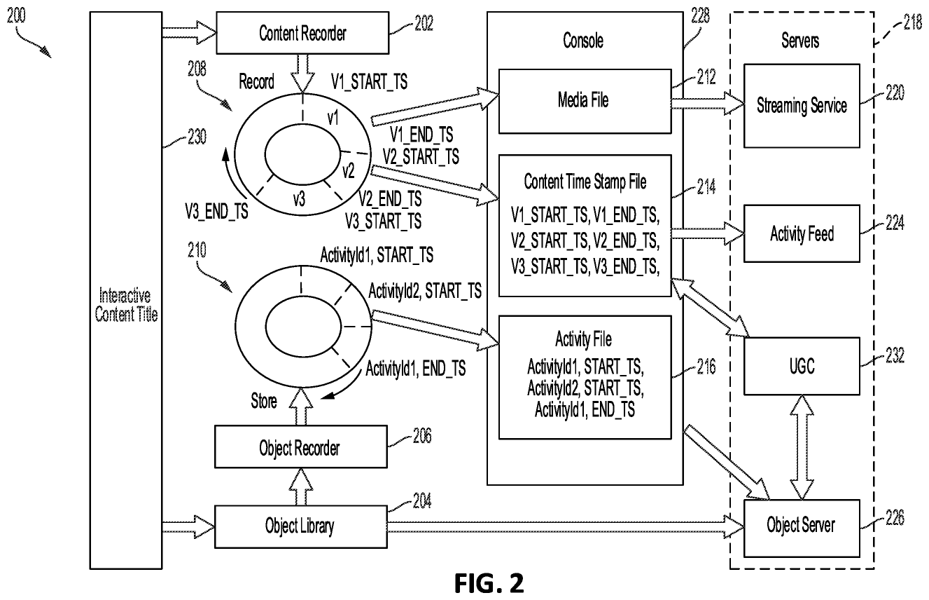

The gameplay analysis servers 110 may receive game data sent from a user device 130 or platform servers 120 over a communication network. Such gameplay analysis servers 110 may be implemented in the cloud (e.g., one or more cloud servers). The gameplay data may include one or more sets of in-game objects, entities, activities, and events engaged by the users associated with one or more media titles such as a video game. The gameplay data may include the type of in-game interaction, location within the in-game environment, point in time within an in-game timeline, other players, and metadata for objects and entities involved. The gameplay data may be stored by the gameplay analysis servers 110, platform servers 120, the user device 130, and/or in databases 140 in an activity file 216, as will be discussed in detail with respect to FIG. 2.

The gameplay analysis servers 110 may analyze the gameplay data received from a plurality of users by organizing the data based on user demographic, user pattern, gameplay style, user needs, the type of activity, outcome of the activity (success or fail), rate of success, and filter relevant data for a specific user. The gameplay analysis servers 110 may utilize AI by training a learning model track the outcomes of each user activity based on the data and generate a customized recommendation for a specific user regarding the activity. The gameplay analysis server 110 may further track the outcome of the specific user after the user executed steps in the recommendation to update the learning model and to provide an updated customized recommendation. The gameplay analysis server 110 may detect a trigger event and provide the customized recommendation automatically upon detecting the trigger event.

The platform servers 120 may be responsible for communicating with the different gameplay analysis servers 110, databases 140, and user devices 130. Such platform servers 120 may be implemented on one or more cloud servers. The game analysis servers 110 may communicate with multiple platform servers 120, though the game analysis servers 110 may be implemented on one or more platform servers 120. The platform servers 120 may also carry out instructions, for example, receiving a user request from a user to play games, activities, video, podcasts, or User Generated Content. The platform servers 120 may further carry out instructions, for example, for receiving, tracking, and recording gameplay data including input data and activity data, from the users via user devices 130 and transmitting the data to the gameplay analysis server 110 or databases 140.

The gameplay data may be received and/or provided through an application programming interface (API) 160, which allows various types of game analysis servers 110 to communicate with different platform servers 120 and different user devices 130. API 160 may be specific to the particular computer programming language, operating system, protocols, etc., of the gameplay analysis servers 110, the platform servers 120 providing the media and the associated at least one set of object data, and user devices 130 receiving the same. In a network environment 100 that includes multiple different types of gameplay analysis servers 110 (or platform servers 120 or user devices 130), there may likewise be a corresponding number of APIs 160.

The user device 130 may include a plurality of different types of computing devices. For example, the user device 130 may include any number of different gaming consoles, mobile devices, laptops, and desktops. In another example, the user device 130 may be implemented in the cloud (e.g., one or more cloud servers). Such user device 130 may also be configured to access data from other storage media, such as, but not limited to memory cards or disk drives as may be appropriate in the case of downloaded services. Such devices 130 may include standard hardware computing components such as, but not limited to network and media interfaces, non-transitory computer-readable storage (memory), and processors for executing instructions that may be stored in memory. These user devices 130 may also run using a variety of different operating systems (e.g., iOS, Android), applications or computing languages (e.g., C++, JavaScript). The user device may include one or more devices associated with a user or a user device capable of displaying on one or more screens. The user devices 130 may receive, track, record, or store gameplay data including input data and activity data and transmit the data to the gameplay analysis server 110.

The databases 140 may be stored on the platform server 120, the game analysis servers 110, any of the servers 218 (shown in FIG. 2), on the same server, on different servers, on a single server, across different servers, or on any of the user devices 130. Such databases 140 may store the gameplay data and metadata associated with gameplay data.

In an exemplary embodiment of the present invention, the user may be using user device 130 to access and engage in interactive content hosted by gameplay analysis servers 110. During gameplay of a particular game title, for example, platform server 120 may analyze gameplay data and identify that the user may be struggling at a particular point (e.g., level, challenge, skill, or other element in virtual environment) in gameplay of the game title. Data regarding the particular in-game activity may also be captured (and described in further detail in relation to FIG. 2) and stored in database(s) 140. Platform server 120 may therefore analyze gameplay data from the current gameplay session in real-time. Such analysis may include evaluation in comparison to historical data of the user or of other similarly situated users in the same or similar game titles as stored in databases 140. A user may be identified a struggling, for example, based on such in-game factors as experience level, skill level, duration of time spent at the identified in-game point, as well as real-world data regarding real-time reactions by the user. The platform server 120 may use the activity data to filter and customize training materials and provide such materials to the user.

Learning models may be used to characterize the session attributes based on user characteristics and behaviors, virtual objects, elements, events, gameplay trajectories and outcomes, etc., The learning models may further correlate different sets of the identified session characteristics to different training content. Such learning models may be generated and refined using artificial intelligence and machine learning techniques (e.g., similar to those used by large language models trained using large data corpora to learn patterns and make predictions with complex data) on historical and current session data, as well as supplemental training content data.

Artificial intelligence and machine learning techniques may further be applied to train a learning model for a particular user based on session data, including game data, which may be captured during interactive sessions of the same or different (but similar) users and user devices. Such game data may include not only information regarding the game and other content titles being played, but also user profiles, chat communications (e.g., text, audio, video), captured speech or verbalizations, behavioral data, in-game events, actions, and behaviors, etc., associated with the interactive session. The game data may be analyzed to determine whether training content may be useful or otherwise suitable to the user. User reactions and comments during the presentation of a particular set of training content (e.g., which may be presented concurrent with a presentation of virtual environment during gameplay on another device), for example, may be used to refine future determinations as to whether to the include the training content in future sessions for the same user or similar users in similar gameplay situations.

In some implementations, other content titles associated with the user (e.g., favorite games, music, books, movies, etc.) may be received from or otherwise discerned in relation to the user, social circles, or service providers, as well as used as bases for selecting training content to provide or present during or in association with a current interactive session. In addition, game data may be monitored and stored in memory as object or activity files, which may be used for supervised and unsupervised learning whereby a model may be trained to recognize patterns between certain game/user data and associated user attributes, as well as to predict which training files that would be suitable for a particular user. In some implementations, sets of the object files or activity files may be labeled in accordance with any combination of game metadata and user feedback during or in association with gameplay sessions.

In exemplary embodiments, media files, object files, and activity files may provide information to learning models regarding current session conditions, which may also be used for evaluating whether training content is helpful, engaging, or otherwise pleasing to the player Learning models may therefore use such recorded files to identify specific conditions of the current session, including players, characters, and objects at specific locations and events in the virtual environment. Based on such files, for example, learning models may identify relevant training content associated with the content title, virtual environment, virtual scene or in-game event (e.g., significant battles, proximity to breaking records), which may be used to dynamically generate an enriched training interactive experience during and throughout the current session.

Such learning models may be updated based on new feedback or analytics of gameplay and user feedback, which may include language, gestures, and behaviors. Where content and content presentation preferences are being analyzed, the model may further apply pattern recognition to user-associated gameplay and interactive sessions to identify common characteristics and to predict which characteristics may be correlated with better feedback, more successful gameplay, higher or more prolonged user engagement, or other outcome metric. User feedback may indicate certain preferences or ways in which the training content may be selected, modified, and/or presented in a manner best-fitting the needs and preferences of the user. Such user feedback may be used not only to tailor subsequent training content for sessions with the specific user, but also for sessions with users identified as sharing similar user attributes. In that regard, the learning models may not only be constructed for or customized to a particular user, but may be used for user groups that share similarities. Further, the system may affirm such associations or patterns by querying a player for feedback on whether the training content was helpful, interesting, or otherwise pleasing to the user and utilize the user feedback to further update and refine the model, as well as monitoring associated or concurrent chat communications and sensor data regarding the user to discern positive or negative reactions. In some implementations, sensor data may also provide data regarding the surrounding environment (e.g., user facial expressions, speech, physical reactions) or gameplay patterns of the user, which may be used to select or modify training content.

The machine learning model may thus be trained to process session data in conjunction with training content data to identify one or more session characteristics that may be positively correlated to certain training content based on, e.g., input or feedback from the user, user characteristics, prior selections or modifications, one or more parameters for the game title, data pertaining to one or more additional users, databases, etc. The identified training content selections and customizations (e.g., different presentation options, preferred AI coach characteristics, skill level-specific content) may thus be correlated to characteristics of a particular game session, which may be presented on one device concurrent with a synchronized presentation of the selected training content. In some embodiments, the training content may be used to supplemented with real-time statistics, aggregated statistics, comparisons to top-ranked players or average players, background materials relating to the game title (e.g., character profiles and back stories, storylines, video clips), etc.

Session data may be captured and stored in activity files that may be provided to machine learning models for analysis as to the current session conditions, e.g., digital content title, what virtual (e.g., in-game) objects, entities, activities, and events that users have engaged with, and thus support analysis of and coordination of training content generation, delivery, and synchronization to current virtual interactive and/or in-game activities. Each user interaction within a virtual environment may be associated with the metadata for the type of virtual interaction, location within the virtual environment, and point in time within a virtual world timeline, as well as other players, objects, entities, etc., involved. Thus, metadata can be tracked for any of the variety of user interactions that can occur in during a current interactive session, including associated virtual activities, entities, settings, outcomes, actions, effects, locations, and character stats. Such data may further be aggregated, applied to learning models, and subject to analytics to make predictions as to the current interactive session, associated training content, and how to synch or otherwise coordinate presentations across a current device setup.

For example, various content titles may depict one or more objects (e.g., involved in in-game activities) with which a user can interact, and associated training content may include user-generated content (e.g., screen shots, videos, commentary, mashups, etc.) created by peers, publishers of the media content titles and/or third party publishers as to a particular virtual character, object, or activity in the current interactive session. Such training content may include metadata by which to search for such training content. The training content may also include information about the media and/or peer. Such peer information may be derived from data gathered during peer interaction with an object of an interactive content title (e.g., a video game, interactive book, etc.) and may be “bound” to and stored with the training content file. Such binding enhances the training content file as the training content file may also include a deep link (e.g., directly launch) to associated objects, events, activities, or other related content.

Different machine learning models may be trained using different types of data input, which may be specific to the user, the user demographic, associated game or other interactive content title(s) and genres thereof, social contacts, etc. Using the selected data inputs, therefore, the machine learning model may be trained to identify attributes of a specific user and identify training content parameters that may be specifically relevant to the requesting user (e.g., cartoon-like content for young children, basic instructional content for beginning players, complex diagrams and strategic content for advanced or expert players).

Identified session attributes may be associated with a different pattern of in-game behaviors and associated training content. A pattern of certain positive actions or reactions towards a type of training content may reinforce associations with certain players or types of gameplay, for example. For example, certain tutorial content presented during certain game sequences may be strongly correlated with improved gameplay and happy or excited user reactions. Similarly, certain training content (e.g., back story, character profiles) may be correlated with increased user interest and prolonged engagement as indicated by user speech and behaviors (real-world and in-game/virtual).

FIG. 2 illustrates an exemplary uniform data system (UDS) that may be used to provide data to a system for providing a customized recommendation. Based on data provided by UDS, a server can be made aware of current session conditions, such as in-game objects, entities, activities, and events that users have engaged with, and thus support analysis of and coordination with in-game activities. Each user interaction may be associated the metadata for the type of in-game interaction, location within the in-game environment, and point in time within an in-game timeline, as well as other players, objects, entities, etc., involved. Thus, metadata can be tracked for any of the variety of user interactions that can occur in during a game session, including associated activities, entities, settings, outcomes, actions, effects, locations, and character stats. Such data may further be aggregated, applied to data models, and subject to analytics. Such a UDS data model may be used to assign contextual information to each portion of information in a unified way across games.

As illustrated in FIG. 2, an exemplary console 228 (e.g., a user device 130) and exemplary servers 218 (e.g., streaming server 220, an activity feed server 224, a user-generated content (UGC) server 232, and an object server 226) are shown. In one example, the console 228 may be implemented on the platform server 120, a cloud server, or on any of the servers 218. In an exemplary example, a content recorder 202 may be implemented on the platform server 120, a cloud server, or on any of the servers 218. Such content recorder 202 receives and records content (e.g., media) from an interactive content title 230 onto a content ring-buffer 208. Such ring-buffer 208 may store multiple content segments (e.g., v1, v2 and v3), start times for each segment (e.g., V1_START_TS, V2_START_TS, V3_START_TS), and end times for each segment (e.g., V1_END_TS, V2_END_TS, V3_END_TS). Such segments may be stored as a media file 212 (e.g., MP4, WebM, etc.) by the console 228. Such media file 212 may be uploaded to the streaming server 220 for storage and subsequent streaming or use, though the media file 212 may be stored on any server, a cloud server, any console 228, or any user device 130. Such start times and end times for each segment may be stored as a content time stamp file 214 by the console 228. Such content time stamp file 214 may also include a streaming ID, which matches a streaming ID of the media file 212, thereby associating the content time stamp file 214 to the media file 212. Such content time stamp file 214 may be uploaded and stored to the activity feed server 224 and/or the UGC server 232, though the content time stamp file 214 may be stored on any server, a cloud server, any console 228, or any user device 130.

Concurrent to the content recorder 202 receiving and recording content from the interactive content title 230, an object library 204 receives data from the interactive content title 230, and an object recorder 206 tracks the data to determine when an object begins and ends. The object library 204 and the object recorder 206 may be implemented on the platform server 120, a cloud server, or on any of the servers 218. When the object recorder 206 detects an object beginning, the object recorder 206 receives object data (e.g., if the object were an activity, user interaction with the activity, activity ID, activity start times, activity end times, activity results, activity types, etc.) from the object library 204 and records the activity data onto an object ring-buffer 210 (e.g., ActivityID1, START_TS; ActivityID2, START_TS; ActivityID3, START_TS). Such activity data recorded onto the object ring-buffer 210 may be stored in the object file 216. Such object file 216 may also include activity start times, activity end times, an activity ID, activity results, activity types (e.g., tutorial interaction, menu access, competitive match, quest, task, etc.), user or peer data related to the activity. For example, an object file 216 may store data regarding an in-game skill used, an attempt to use a skill, or success or failure rate of using a skill during the activity. Such object file 216 may be stored on the object server 226, though the object file 216 may be stored on any server, a cloud server, any console 228, or any user device 130.

Such object data (e.g., the object file 216) may be associated with the content data (e.g., the media file 212 and/or the content time stamp file 214). In one example, the UGC server 232 stores and associates the content time stamp file 214 with the object file 216 based on a match between the streaming ID of the content time stamp file 214 and a corresponding activity ID of the object file 216. In another example, the object server 226 may store the object file 216 and may receive a query from the UGC server 232 for an object file 216. Such query may be executed by searching for an activity ID of an object file 216 that matches a streaming ID of a content time stamp file 214 transmitted with the query. In yet another example, a query of stored content time stamp files 214 may be executed by matching a start time and end time of a content time stamp file 214 with a start time and end time of a corresponding object file 216 transmitted with the query. Such object file 216 may also be associated with the matched content time stamp file 214 by the UGC server 232, though the association may be performed by any server, a cloud server, any console 228, or any user device 130. In another example, an object file 216 and a content time stamp file 214 may be associated by the console 228 during creation of each file 216, 214.

The activity files captured by UDS 200 may be accessed by the platform server 120 as to the user, the game title, the specific activity being engaged by the user in a game environment of the game title, and similar users, game titles, and in-game activities. Such data may be compared to data from the current gameplay session to identify with granularity user game patterns, styles, and needs. For example, the platform server 120 may identified that players successfully engaging in the same activity may have performed a particular move associated with a specific combination of input, while also identifying that user input appears to be similar but does not quite match the specific combo. The platform server 120 may therefore filter the available training materials to identify the materials relevant to the specific combo (e.g., controller layout with the specific input buttons marked or numbered, video of past players who used the combo, tips associated with the combo). The filtered training materials may further be provided to the user in accordance with a profile that includes express preferences and historical habits.

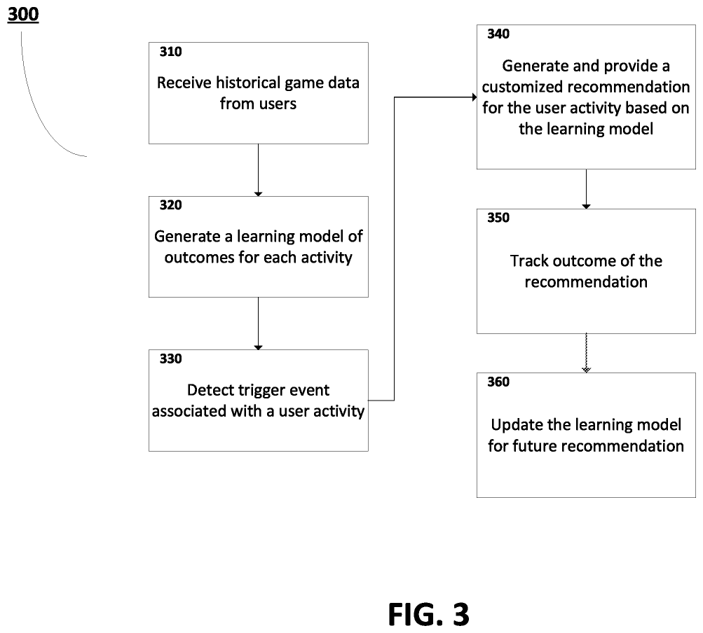

FIG. 3 is a flowchart illustrating an exemplary method 300 for the virtual gameplay coach. Each step in FIG. 3 may be carried out by the system 100. The steps identified in FIG. 3 are exemplary and may include various alternatives, equivalents, or derivations thereof including but not limited to the order of execution of the same. The steps of the process of FIG. 3 and any alternative similar processes may be embodied in hardware or software including a computer-readable storage medium including instructions executable by the likes of a processor in a computing device. The exemplary process illustrated in FIG. 3 may be performed repeatedly during the play of a game.

The method 300 begins at step 310, in which the system receives historical game data from one or more users on a virtual platform. The historical game data may include the type of in-game interaction, location within the in-game environment, point in time within an in-game timeline, features of the game, other players, and metadata for objects and entities involved. The metadata may include the name of the game, the type or genre of the game, the type of virtual interaction, location within the virtual environment, and point in time within a virtual world timeline, as well as other players, objects, entities, etc., involved. The features of the games may include interactive objects, the level, progress, or milestones within the game, health/status, equipment, inventory, number of points, structures or building, the background environment, color palette, sounds, character selection, etc. The one or more users may be users of one particular media, users from the same server, on different servers, or of different demographics. The virtual platform may be platform servers 120 or user devices 130.

The received historical game data may be analyzed to identify the pattern of play, personality, mood, favorite title, favorite characters, play style of a particular user. The play style of the particular user may be determined by preferences indicated by a choice of in-game action or inaction, a choice of type of in-game character, a choice of inventory, the time taken for each activity, a choice in engagement with an interactive object, a genre of games played, the number of hours played for the genre of games, player rank, etc. The pattern of play may be determined based on data collected by a UDS 200. The gaming style of a user across games and genres may be analyzed by assigning a weight for preferred gaming styles. Preferred gaming style weights may be determined by consistent preferences detected across gameplay of one or more games of a user. For example, a user engaging in similar activities in a game repeatedly or across multiple games may be analyzed to be a weighted preference of user gaming style. Further, as more data is collected by a UDS 200, and a user continues to engage in similar activities, a related weighted preference for an activity may be determined as important to a user and will increase in importance the more frequently and consistently a user engages in an activity or behavior. A recent gameplay data or a pattern of gameplay data may be weighted more heavily to account for the current mood of the user.

The game data may also be analyzed to identify a type of activity of a plurality of users at a particular location in a game, the same or similar activities in a different location in a game. For example, the game data may be organized to group together the jumps over a cliff of in-game characters made in a certain level, location, or timeframe of the game by various users to be analyzed. The game data may also be organized to group together the jumps over a cliff of in-game characters made in a different level, location, or timeframe of the game by various users, or group together similar jumps over different obstacles.

At step 320, a learning model of outcomes may be generated that associates each user activity with the outcomes based on the received gameplay data in step 310. AI may be utilized to generate the learning model. The learning model may be utilized to associate a certain task within a game with various steps the plurality of users executed to accomplish the task. The learning model may be utilized to further associate the various steps taken for the in-game activity with their respective outcomes. The steps may be registered as controller button inputs, physical gestures of the user, voice inputs, and/or various in-game conditions reached during the in-game activity. Such in-game conditions may include the speed, acceleration, force, direction, or view angle of the in-game character, timing and location of each of the executed steps, a choice of path, and/or a choice in a storyline.

The learning model may further associate user activities with the respective outcomes for similar activities. Activities may be defined as similar if the activities involve the same or relatively same steps, outcome, and skill even if the activities occur at a different locations or timeline within a video game.

The learning model may further associate the user activities with the respective outcomes for similar type of users. The users may be defined as similar if the users share characteristics of gameplay style, demographics, pattern of choices, user ranking, skill level, genre of games, or a favorite in-game character. The different categories of similarities may be tracked with their respective outcomes.

Using the learning model, the outcome may be analyzed based on the success rate of the certain steps taken to accomplish the in-game activity. Further, relevant data may be filtered to generate the customized coaching based on the learning model. Such relevant data may be based on the success rate associated with the in-game activity over a threshold value, the gameplay patterns, the gameplay style, in-game needs, and the mood of the user. For example, a recommendation may be generated for the particular steps and in-game conditions achieved by the similar type of users only when those steps in aggregate have a success rate over 50%.

At step 330, a trigger event associated with a user activity may be detected for generating virtual gameplay coaching. A trigger event may be associated with a manual trigger, such as a user selecting an in-game help menu or querying for a solution to the activity. A trigger event may be associated with an automatic trigger, such as an increase or a decrease in the user skill in a particular game skill, the failure of the user to execute a certain skill or achieve an objective, repeated failures to execute the certain skill or similar skills, a long pause or inactivity, lack of improvement in success rate of executing the skill, lack of progress within the game, increase or decrease in a player rank, or determination of previous disengagement with the game after a failure to execute a skill. A trigger event may further be associated with failure rate of other users globally or other similar users that have attempted to execute the skill. For example, if over 50% of all players who have participated in the particular in-game activity failed to execute the skill, the customized recommendation may be triggered. Different trigger events or type of trigger events may trigger generating a different customized recommendation associated with the user activity.

A variety of different thresholds for detecting a trigger event may be set for users with a different skill level, familiarity with the platform or user device, different stages or timeline in the game, a number of failures or repeated failures. For example, a lower threshold may be set for a beginner than an advance player, to avoid generating a recommendation for the advanced player for an anomalous accident. In another example, a lower threshold may be set in the beginning of the game rather than in later stages of the game to provide a greater level of assistance in the beginning of the game. In another example, a higher threshold may be set for repeated failures of the same skill. Thresholds for trigger events may be set to a predetermined value by a gameplay analysis servers 110, a developer or publisher of a game, or a user device 130 for a user with no historic gameplay data available for a particular skill.

At step 340, a customized recommendation may be generated associated with the user activity. The recommendation may be in a form of tutorial, educational coaching, an interactive assistant, a hint, a clue, a warning, or a partial solution to the user activity. A partial solution may be a guidance to the first few steps of the user activity to encourage the user to solve the problem independently after the guidance. A recommendation in a form of a warning may be generated if greater than a threshold value of failure rate of other users globally have been detected for the activity the user is about to engage in. In such a case, the trigger event may be the cumulative failure rate of global users being above a threshold level. The recommendation may be provided within a game, outside of the game, in full or partial screen tutorial or as overlays, or interstitial displays. The recommendation may be provided as texts, images, audios, videos, animations, one or more interactive objects, buttons, icons, paths, outlines, or tactile instructions.

The recommendation may be customized based on the needs of the user, user pattern, and the user demographic. The needs of the user may be identified based on the trigger event being detected. The needs of the user may be based on number of failures in executing a skill, rate of failures, or a difference in the skill of the user and the skill required to complete the task. In one example, the recommendation for a type of user may be based on the same type of other users successfully executing an in-game activity using a certain skill.

The recommendation may be customized based on the trigger event. Different trigger events may trigger different recommendations. In one example, a trigger event associated with an incomplete task may be associated with a recommendation on how to complete the task faster or to complete the task with more points. In another example, a trigger event associated with lack of dexterity or insufficient skill may be associated with a recommendation on improving the dexterity or skill of a user. Yet in another example, a general tutorial may be provided based on detecting that a user failed to execute a skill once. Upon detecting a repeated failure of the skill, a more detailed, specific, and step-by-step tutorial incorporating more than one learning styles (visual, auditory, or kinesthetic) may be provided.

At step 350, the outcome of the recommendation may be tracked. The user activity in response to the recommendation may be analyzed by the gameplay analysis servers 110. The analysis of the outcome may include identifying the steps the user has taken during the user activity, such as a sequence of controller button inputs, physical gestures of the user, voice inputs, and/or various in-game conditions reached during the in-game activity. Such in-game conditions may include the speed, acceleration, force, direction, or view angle of the in-game character, timing and location of each of the executed steps, a choice of path, and/or a choice in a storyline.

The analysis of the outcome may include identifying whether the user was successful in the executing the skill associated with the user activity. The success may be measured by correctly executing a skill, advancing to the next stage, or achieving an in-game objective. The analysis may further include determining which recommendation had the best or the most optimal outcome. In such a case, the recommendation that produced the optimal outcome may further be used to update a pattern or type of user so that a future recommendation may be in a form of a similar type or style of recommendation.

At step 360, the outcome in response to the recommendation in association with the user activity may be used to update the learning model. The learning model may be updated with the steps the user has taken and the associated outcomes such that the subsequent recommendation may be based on the updated learning model. In other words, the outcome in response to the recommendation in association with the user activity may be used to update future recommendation. The outcome of the user in response to the recommendation, the steps the user has taken in accomplishing the outcome, and the updated learning model may be transmitted via the network to the gameplay analysis servers 110 or user devices of another user to be used for generating a recommendation for another user playing the same game. For example, if a user was successful in completing an in-game task after following a recommendation, the same recommendation may be provided to a different user executing the same task sometime in the future. In another example, if a user is still failing the task after being provided a recommendation or the user refuses to follow the recommendation, a different recommendation may be provided than what was previously provided to the user.

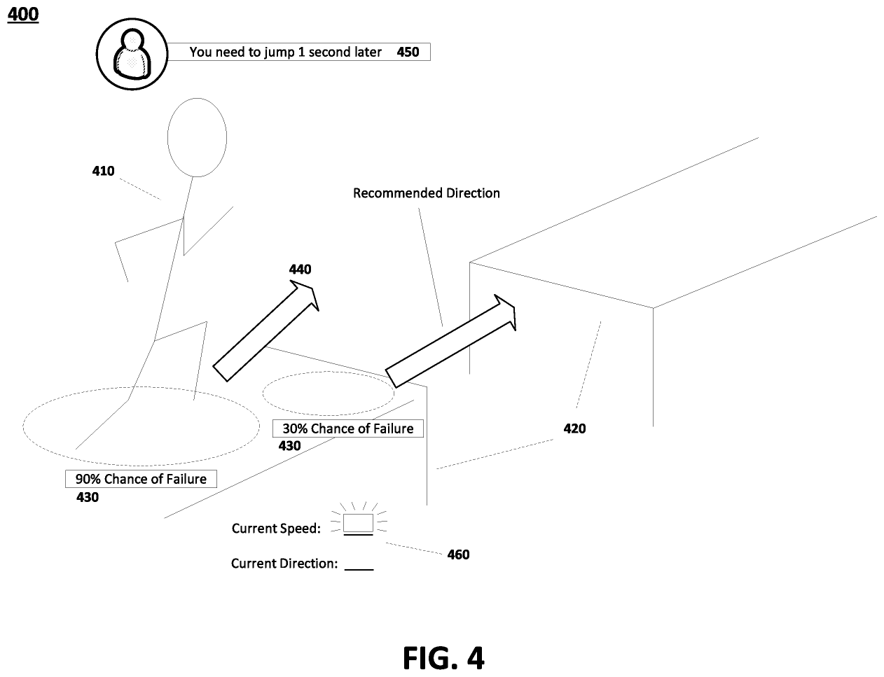

FIG. 4 illustrates an exemplary graphical user interface display. The exemplary graphical user interface display 400 may include an avatar of the user 410, in-game object 420, and various overlay recommendations 430, 440, 450 and 460. The recommendation may be in the form of text as illustrated in 430, which displays the determined chance of failures based on a cumulative historical data when users tried to jump from particular in-game locations. The recommendation may be in the form of an image as illustrated in 440, which displays the current and recommended directional path of the user. The image 440 may further indicate a projected path. The image 440 may be highlighted, enlarged, change color, or animate if the avatar of the user 410 matches the projected path. The recommendation may be in the form of an advice 450 provided by an animated in-game assistant based on the previous action taken by the user during the same activity or a similar activity. The display may further include a current in-game condition of the user to assist the user in meeting the condition for a successful execution of the skill. For example, the current speed number may be highlighted or in a different color if the success rate of the skill at the current speed is lower than 25% as illustrated in element 460.

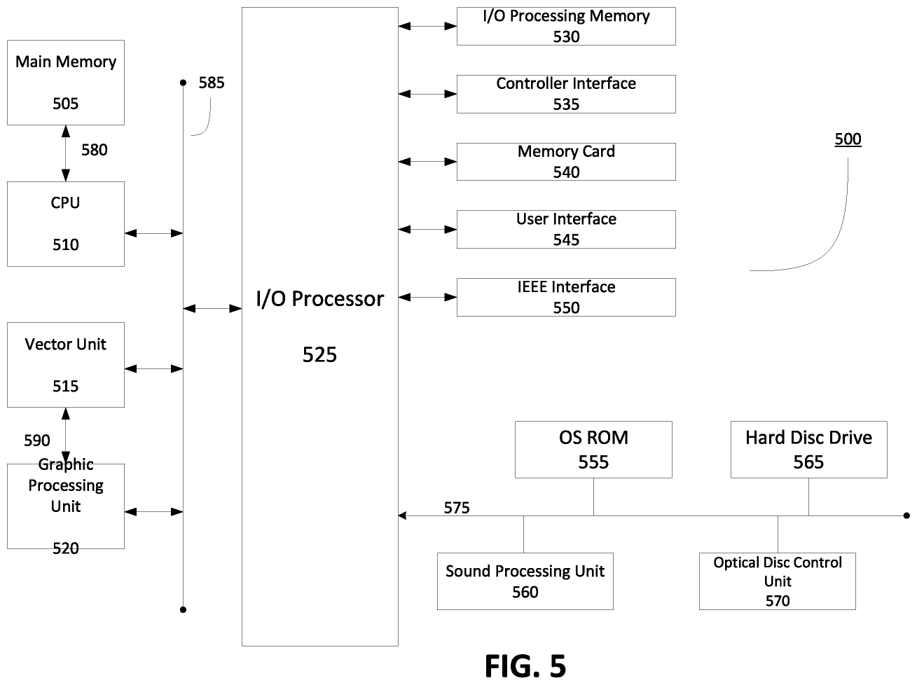

FIG. 5 illustrates a block diagram of an exemplary electronic entertainment system 500 in accordance with an embodiment of the presently disclosed invention. The electronic entertainment system 500 as illustrated in FIG. 5 includes a main memory 502, a central processing unit (CPU) 504, graphic processor 506, an input/output (I/O) processor 508, a controller input interface 510, a hard disc drive or other storage component 512 (which may be removable), a communication network interface 514, a virtual reality interface 516, sound engine 518, and optical disc/media controls 520. Each of the foregoing are connected via one or more system buses 522.

Electronic entertainment system 500 as shown in FIG. 5 may be an electronic game console. The electronic entertainment system 500 may alternatively be implemented as a general-purpose computer, a set-top box, a hand-held game device, a tablet computing device, or a mobile computing device or phone. Electronic entertainment systems may contain some or all of the disclosed components depending on a particular form factor, purpose, or design.

Main memory 502 stores instructions and data for execution by CPU 504. Main memory 502 can store executable code when the electronic entertainment system 500 is in operation. Main memory 502 of FIG. 5 may communicate with CPU 504 via a dedicated bus. Main memory 502 may provide pre-stored programs in addition to programs transferred through the I/O processor 508 from hard disc drive/storage component 512, a DVD or other optical disc (not shown) using the optical disc/media controls 520, or as might be downloaded via communication network interface 514.

The graphics processor 506 of FIG. 5 (or graphics card) executes graphics instructions received from the CPU 504 to produce images for display on a display device (not shown). The graphics processor 506 of FIG. 5 may transform objects from three-dimensional coordinates to two-dimensional coordinates, and vice versa. Graphics processor 506 may use ray tracing to aid in the rendering of light and shadows in a game scene by simulating and tracking individual rays of light produced by a source. Graphics processor 506 may utilize fast boot and load times, 4K-8K resolution, and up to 120 FPS with 120 hz refresh rates. Graphics processor 506 may render or otherwise process images differently for a specific display device.

I/O processor 508 of FIG. 5 may also allow for the exchange of content over a wireless or other communications network (e.g., IEEE 802.x inclusive of Wi-Fi and Ethernet, 5G, 4G, LTE, and 5G mobile networks, and Bluetooth and short-range personal area networks). The I/O processor 508 of FIG. 5 primarily controls data exchanges between the various devices of the electronic entertainment system 500 including the CPU 504, the graphics processor 506, controller interface 510, hard disc drive/storage component 512, communication network interface 514, virtual reality interface 516, sound engine 518, and optical disc/media controls 520.

A user of the electronic entertainment system 500 of FIG. 5 provides instructions via a controller device communicatively coupled to the controller interface 510 to the CPU 504. A variety of different controllers may be used to receive the instructions, including handheld and sensor-based controllers (e.g., for capturing and interpreting eye-tracking-based, voice-based, and gestural commands). Controllers may receive instructions or input from the user, which may then be provided to controller interface 510 and then to CPU 504 for interpretation and execution. The instructions may further be used by the CPU 504 to control other components of electronic entertainment system 500. For example, the user may instruct the CPU 504 to store certain game information on the hard disc drive/storage component 512 or other non-transitory computer-readable storage media. A user may also instruct a character in a game to perform some specified action, which is rendered in conjunction with graphics processor 506, inclusive of audio interpreted by sound engine 518.

Hard disc drive/storage component 512 may include removable or non-removable non-volatile storage medium. Saud medium may be portable and inclusive of digital video disc, Blu-Ray, or USB coupled storage, to input and output data and code to and from the main memory 502. Software for implementing embodiments of the present invention may be stored on such a medium and input to the main memory via the hard disc drive/storage component 512. Software stored on hard disc drive 512 may also be managed by optical disk/media control 520 and/or communications network interface 514.

Communication network interface 514 may allow for communication via various communication networks, including local, proprietary networks and/or larger wide-area networks such as the Internet. The Internet is a broad network of interconnected computers and servers allowing for the transmission and exchange of Internet Protocol (IP) data between users connected through a network service provider. Examples of network service providers include public switched telephone networks, cable or fiber services, digital subscriber lines (DSL) or broadband, and satellite services. Communications network interface allows for communications and content to be exchanged between the various remote devices, including other electronic entertainment systems associated with other users and cloud-based databases, services and servers, and content hosting systems that might provide or facilitate game play and related content.

Virtual reality interface 516 allows for processing and rendering of virtual reality, augmented reality, and mixed reality data. This includes display devices such that might be partial or entirely immersive virtual environments. Virtual reality interface 516 may allow for exchange and presentation of immersive fields of view and foveated rendering in coordination with sounds processed by sound engine 518 and haptic feedback.

Sound engine 518 executes instructions to produce sound signals that are outputted to an audio device such as television speakers, controller speakers, stand-alone speakers, headphones or other head-mounted speakers. Different sets of sounds may be produced for each of the different sound output devices. This may include spatial or three-dimensional audio effects.

Optical disc/media controls 520 may be implemented with a magnetic disk drive or an optical disk drive for storing, managing, and controlling data and instructions for use by CPU 504. Optical disc/media controls 520 may be inclusive of system software (an operating system) for implementing embodiments of the present invention. That system may facilitate loading software into main memory 502.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

1. A method for providing virtual coaching, the method comprising:
storing historical game data associated with gameplay of a game title in memory, wherein the historical game data includes a plurality of activities available in the game title;
receiving game data of a current session over a communication network from a user device of a user;
constructing a learning model for each activity based on a set of historical game data associated with the user and one or more other users similarly situated to the user, wherein the learning model is trained to identify one or more activity characteristics associated with the respective activity;
generating a customized recommendation for an identified activity by applying the learning model to the game data of the current session in which the user device of the user is playing the game title, wherein the recommendation includes one or more steps for achieving an in-game objective associated with the identified activity;
tracking an outcome of the recommendation after the steps are determined to have been performed, wherein the outcome is included in updated game data of the current session; and
updating the learning model based on the outcome, wherein the updated learning model is used to generate a subsequent customized recommendation in relation to a subsequent performance of the identified activity.

2. The method of claim 1, wherein the historical game data further includes metadata regarding one or more associated training content files, and wherein generating the customized recommendation includes identifying one or more of the training content files associated with the identified activity.

3. The method of claim 1, wherein the historical game data further includes a sequence of user inputs associated with the activities.

4. The method of claim 1, wherein constructing the learning model of outcomes includes analyzing the historical game data associated with similar activities, and identifying that the similar activities share a characteristic.

5. The method of claim 1, wherein generating the customized recommendation is further based on a cumulative failure rate associated with one or more users engaged in the identified activity, the cumulative failure rate exceeding a threshold level.

6. The method of claim 1, wherein generating the customized recommendation is further based on the steps having been executed by the other users that have engaged in the identified activity, wherein the other users share a characteristic with the user.

7. The method of claim 1, wherein generating the customized recommendation is further based on a pattern of activities in which the user has been engaged.

8. The method of claim 7, further comprising weighting the pattern of activities based on recency, wherein generating the customized recommendation is further based on the weighted pattern of activities.

9. The method of claim 1, wherein generating the customized recommendation is further based on a difference between a skill level of the user and a required skill level for the identified activity.

10. The method of claim 1, wherein the customized recommendation corresponds to one task of a plurality of different tasks associated with the identified activity.

11. The method of claim 1, further comprising providing the customized recommendation to the user device as an overlay to present over a display of the current session.

12. The method of claim 1, further comprising detecting a trigger event associated with the identified activity based on the game data of the current session, wherein the customized recommendation is generated upon detection of the trigger event.

13. The method of claim 12, wherein detecting the trigger event includes identifying that a threshold level associated with the trigger event has been met.

14. The method of claim 12, further comprising generating a different customized recommendation based on detecting a different trigger event.

15. The method of claim 12, wherein detecting the trigger event includes identifying that the user failed to execute a skill associated with the identified activity.

16. The method of claim 1, further comprising providing a second user with a different customized recommendation based on application of the updated learning model to game data of the second user.

17. A system for providing virtual coaching, the system comprising:
memory that stores historical game data associated with gameplay of a game title, wherein the historical game data includes a plurality of activities available in the game title;
a communication interface that communicates over a communication network, wherein the communication interface receives game data of a current session from a user device of a user; and
a processor that executes instructions stored in memory, wherein the processor executes the instructions to:
construct a learning model for each activity based on a set of historical game data associated with the user and one or more other users similarly situated to the user, wherein the learning model is trained to identify one or more activity characteristics associated with the respective activity;
generate a customized recommendation for an identified activity by applying the learning model to the game data of the current session in which the user device of the user is playing the game title, wherein the recommendation includes one or more steps for achieving an in-game objective associated with the identified activity;
track an outcome of the recommendation after the steps are determined to have been performed, wherein the outcome is included in updated game data of the current session; and
update the learning model based on the outcome, wherein the updated learning model is used to generate a subsequent customized recommendation in relation to a subsequent performance of the identified activity.

18. A non-transitory computer-readable storage medium, having embodied thereon a program executable by a processor to perform a method for providing virtual coaching, the method comprising:
storing historical game data associated with gameplay of a game title in memory, wherein the historical game data includes a plurality of activities available in the game title;
receiving game data of a current session over a communication network from a user device of a user;
constructing a learning model for each activity based on a set of historical game data associated with the user and one or more other users similarly situated to the user, wherein the learning model is trained to identify one or more activity characteristics associated with the respective activity;
generating a customized recommendation for an identified activity by applying the learning model to the game data of the current session in which the user device of the user is playing the game title, wherein the recommendation includes one or more steps for achieving an in-game objective associated with the identified activity;
tracking an outcome of the recommendation after the steps are determined to have been performed, wherein the outcome is included in updated game data of the current session; and
updating the learning model based on the outcome, wherein the updated learning model is used to generate a subsequent customized recommendation in relation to a subsequent performance of the identified activity.
